(19) United States
(12) Patent Application Publication
(10) Pub. No.: US 2015/0045924 A1
(43) Pub. Date: Feb. 12, 2015

(54) DATA PROCESSING

(71) Applicant: MATERIALISE NV, Leuven (BE)

(72) Inventors: Tom CLUCKERS, Kuringen (BE); Kurt RENAP, Herenthout (BE)

(21) Appl. No.: 14/457,043

(22) Filed: Aug. 11, 2014

(30) Foreign Application Priority Data
Aug. 12, 2013 (GB) 1314421.7

(51) Int. Cl. B29C 67/00; G06F 17/50

(52) U.S. Cl. CPC B29C 67/0088; G06F 17/50
USPC 700/98

(57) ABSTRACT

Described herein are data processing apparatuses and methods for processing data relating to at least part of a three dimensional object for additive manufacturing. The apparatuses and methods, for example, relate to processing surface precursor data indicative of at least one characteristic for use in defining a surface of the at least part of the three dimensional object.

### PRIORITY CLAIM

This application claim priority under 35 U.S.C. §119(a) to Great Britain Patent Application GB 1314421.7, filed on Aug. 12, 2013, which is hereby incorporated by reference in its entirety.

### TECHNICAL FIELD

The present application relates to a method and apparatus in relation to processing data, particularly data relating to at least part of a three dimensional object for additive manufacturing.

### BACKGROUND

The technique of additive manufacturing, which may otherwise be referred to as three dimensional (3D) printing, allows certain objects to be manufactured simply and cost effectively.

One advantage of additive manufacturing is that complex and intricate structures may be manufactured simply. Such complex structures may for example include a porous structure and/or intricate surface detail.

Data representative of a 3D object for additive manufacture may be stored according to the stereolithography (STL) data format. The STL data format is widely used in the additive manufacturing industry and is used to represent the surface of a 3D object for additive manufacture with a mesh of tessellating triangles, i.e. a triangular mesh.

Another data format for storing data representative of a 3D object for additive manufacture is the additive manufacturing data format (AMF). Similar as in the STL data format, a surface of a 3D object is represented using data representative of a triangular mesh.

Particularly for complex and intricate structures to be additively manufactured, the size of the data held by STL or AMF data can be significant. Thus, generating or processing STL or AMF data can take a prolonged time. Moreover, transferring large STL or AMF data over a network can cause delays or require greater resources such as channel bandwidth for transferring the data files. Further, the hardware requirements for processing and storing large STL or AMF data can be demanding and expensive.

It is desirable to mitigate at least one of these disadvantages.

### SUMMARY

According to a first aspect, there is provided a method of processing data relating to at least part of a three dimensional object for additive manufacturing, the method including: processing surface precursor data indicative of at least one characteristic for use in defining a surface of the at least part of the three dimensional object.

According to a second aspect, there is provided a method of processing data relating to at least part of a three dimensional object for additive manufacturing, the method including: receiving surface precursor data indicative of at least one characteristic for use in defining a surface of the at least part of the three dimensional object; processing said surface precursor data, thereby generating slice data corresponding to at least one slice of the at least part of the three dimensional object; and transmitting said slice data to additive manufacturing apparatus, for instructing the additive manufacturing apparatus to additively manufacture said at least part of the three dimensional object.

According to a third aspect, there is provided a method of generating data relating to at least part of a three dimensional object for additive manufacturing, the method including: processing surface data representative of a surface of the at least part of the three dimensional object, thereby generating surface precursor data indicative of at least one characteristic for use in defining the surface of the at least part of the three dimensional object.

According to a fourth aspect, there is provided apparatus for processing data relating to at least part of a three dimensional object for additive manufacturing, the apparatus comprising: at least one processor; and at least one memory including computer program instructions, the at least one memory and the computer program instructions being configured to, with the at least one processor, cause the apparatus to perform: a method of processing data relating to at least part of a three dimensional object for additive manufacturing, the method including: processing surface precursor data indicative of at least one characteristic for use in defining a surface of the at least part of the three dimensional object.

According to a fifth aspect, there is provided apparatus for processing data relating to at least part of a three dimensional object for additive manufacturing, the apparatus comprising: at least one processor; and at least one memory including computer program instructions, the at least one memory and the computer program instructions being configured to, with the at least one processor, cause the apparatus to perform: a method of generating data relating to at least part of a three dimensional object for additive manufacturing, the method including: processing surface precursor data indicative of at least one characteristic for use in defining a surface of the at least part of the three dimensional object.

According to a sixth aspect, there is provided apparatus for processing data relating to at least part of a three dimensional object for additive manufacturing, the apparatus comprising: at least one processor; and at least one memory including computer program instructions, the at least one memory and the computer program instructions being configured to, with the at least one processor, cause the apparatus to perform a method of processing data relating to at least part of a three dimensional object for additive manufacturing, the method including: receiving surface precursor data indicative of at least one characteristic for use in defining a surface of the at least part of the three dimensional object; processing said surface precursor data, thereby generating slice data corresponding to at least one slice of the at least part of the three dimensional object; and transmitting said slice data to additive manufacturing apparatus, for instructing the additive manufacturing apparatus to additively manufacture said at least part of the three dimensional object.

According to a seventh aspect, there is provided a computer program product comprising a non-transitory computer-readable storage medium having computer readable instructions stored thereon, the computer readable instructions being executable by a computerized device to cause the computerized device to perform a method of processing data relating to at least part of a three dimensional object for additive manufacturing, the method including: processing surface precursor data indicative of at least one characteristic for use in defining a surface of the at least part of the three dimensional object.

According to an eighth aspect, there is provided computer software for processing data relating to at least part of a three dimensional object for additive manufacturing, the computer software being adapted to process surface precursor data indicative of at least one characteristic for use in defining a surface of the at least part of the three dimensional object.

According to a ninth aspect, there is provided a record carrier comprising a data structure including surface precursor data indicative of at least one characteristic for use in defining a surface of at least part of a three dimensional object for additive printing, the surface precursor data being processable for use in defining a surface of the at least part of the three dimensional object.

Further features will become apparent from the following description of examples, given by way of example only, which is made with reference to the accompanying drawings.

### BRIEF DESCRIPTION OF THE DRAWINGS

FIG. 1 shows schematically an example of data processing apparatus;

FIG. 2 shows schematically an example of a computer;

FIG. 3 shows schematically an example of a method of processing data;

FIG. 4 shows schematically an example of a build processor;

FIG. 5 shows schematically an example of a wireframe;

FIGS. 6 and 7 show schematically an example of processing the wireframe of FIG. 5;

FIG. 8 shows schematically an example of an object to be 3D printed; and

FIG. 9 shows schematically an example of a plurality of slices.

### DETAILED DESCRIPTION

Examples described herein relate to additive manufacturing, which may otherwise be referred to as 3D printing. Examples of additive manufacturing techniques and apparatus will first be described. Then, a description of processing data relating to additive manufacturing will be given, referring to examples of apparatus configured for such processing. It should be appreciated that such examples are not limiting, and that alternative examples of additive manufacturing techniques, data processing, and apparatus may be used in accordance with aspects defined by the accompanying claims.

A common feature of many additive manufacturing techniques involves creating a 3D object layer by layer. Therefore, an object may be printed by printing a series of consecutive layers, the next layer in the series being printed on the previously printed layer. Each layer corresponds with two dimensional a cross-sectional slice of the object to be printed. A thickness of material to be printed for each layer is determined in dependence on factors including for example the material being printed, any curing or hardening technique for each layer before printing the next consecutive layer, and the geometry and intricacy of the object being printed.

Examples of some known additive manufacturing techniques and apparatus will now be given. The terms additive manufacture and 3D printing are used interchangeably.

Stereolithography (“SLA”), for example, uses a vat of a liquid photopolymer compound, such as a resin, for printing an object a layer at a time. In an example, a layer of liquid resin is first deposited over an area on which an object is to be printed. For example, a first layer of resin may be deposited on a base plate of an additive manufacturing apparatus. An electromagnetic ray then traces a specific pattern on the surface of the liquid resin. The electromagnetic ray may be delivered as one or more laser beams which are computer-controlled. Exposure of the resin to the electromagnetic ray cures, or solidifies, the resin according to the pattern traced by the electromagnetic ray, and, if the layer being printed is not the first, the exposure causes the exposed resin to adhere to a previously printed layer below. The specific pattern corresponds with the parts of the layer of the object being printed which are to be formed by the liquid resin. Once a layer of resin has been applied and cured or solidified, the first layer has been printed. Then, the base plate may be lowered by the thickness of a single printed layer and a subsequent layer of liquid resin deposited. To print the next layer, a specific pattern is traced by the electromagnetic ray on the previously printed layer of resin, and the newly traced layer is adhered to the previously printed layer through curing and/or solidifying. A complete 3D object may be formed by repeating this process layer by layer. When complete, the solidified 3D object may be removed from the SLA system and processed further in a post-processing technique. Such post-processing may include cleaning techniques to remove chemicals from manufacture, for example. Examples of SLA apparatus are manufactured by 3D Systems of address 333 Three D Systems Circle, Rock Hill, S.C. 29730 USA, with model names SLA 250, SLA 3500, SLA 7000, Projet 360, 460, 660, 860, Projet 510, 3500, 5000, 6000, 7000, iPro 8000 or iPro 9000.

Selective laser sintering (“SLS”) is another additive manufacturing technique that uses a high power laser, or another focused energy source, to fuse small fusible particles of solidifiable material. In some examples, selective laser sintering may also be referred to as selective laser melting. In some examples, the high power laser may be a carbon dioxide laser for use in the printing of, for example, polymer powdered material. In some examples, the high power laser may be a fibre laser for use in the printing of, for example, metallic powdered material. Other types of high power lasers may be used depending on the particular application. The particles may be fused by sintering or welding the particles together using the high power laser. The small fusible particles of solidifiable material may be made of plastic powders, polymer powders, metal (direct metal laser sintering) powders, or ceramic powders (e.g., glass powders, and the like). The fusion of these particles yields an object that has a desired 3D shape. For example, a first layer of powdered material may be deposited on a base plate on which an object is to be printed. A laser may be used to selectively fuse the first layer of powdered material by scanning the powdered material to create and shape a first cross-sectional layer of the 3D object. After each layer is scanned and each cross-sectional layer of the object is shaped, the base plate may be lowered by one layer thickness, a new layer of powdered material may be applied on top of the previous layer, and the process of scanning a cross section with the laser may be repeated, layer by layer, until all layers have been printed, thus generating the object. To complete the object, it may be necessary to remove excess powder which hasn't been scanned with the laser from around the printed object. Examples of SLS apparatus are manufactured by 3D Systems, with model names Sinterstation Vanguard, Sinterstation HiQ, sPro 140, sPro 230, sPro 60, and other examples of SLS apparatus are manufactured by EOS GmbH of address Robert-Stirling-Ring 1, D-82152 Krailling, Germany, with model names EOS P100 Formiga, EOS P300, P360, P380, P395, P70 or P760.

Materials for printing an object in SLA or SLS include, but are not limited to, polyurethane, polyamide, polyamide with additives such as glass or metal particles, resorbable materials such as polymer-ceramic composites, etc. Examples of commercially available materials include: DSM Somos® series of materials 7100, 8100, 9100, 9420, 10100, 11100, 12110, 14120 and 15100 from DSM Somos of address Het Overloon 1, 6411 TE Heerlen, The Netherlands; Accura Plastic, DuraForm, CastForm, Laserform and VisiJet line of materials from 3D-Systems; Aluminium, CobaltChrome and Stainless Steel materials; Maraging Steel; Nickel Alloy; Titanium; the PA line of materials, PrimeCast and PrimePart materials and Alumide and CarbonMide from EOS GmbH.

In fused deposition modelling (FDM), this being another 3D printing technique, a nozzle dispenses molten material to print an object layer by layer. The molten material may be provided by melting a solid plastic filament, which is continuously fed to the nozzle as the molten material is dispensed. For example, the first layer of an object to be printed may be dispensed on a base plate of fused deposition printing apparatus, according to a pattern which corresponds with the cross section of the object layer to be printed. The base plate and/or nozzle position may be controlled so that the molten material is dispensed according to the desired pattern. The printed material may harden immediately after being dispensed, by cooling. For printing the next layer of the object, the base plate may be lowered by one printed layer thickness, and/or the dispensing nozzle may be re-positioned to print the next layer according to the desired pattern. This layer by layer printing continues until the object is complete. Examples of FDM apparatus are manufactured by Stratasys of address 7665 Commerce Way, Eden Prairie, Minn. 55344, USA, with model names Titan, Vantage, Fortus 400mc, Fortus 250mc or Fortus 900mc.

A further example of a 3D printing technique is so called polyjet printing. In this technique a plurality of nozzles each selectively dispense a photopolymer to print an object one layer at a time. After dispensing each layer of photopolymer the photopolymer may be cured using for example ultraviolet light, before printing the next layer of the object. Examples of polyjet apparatus are manufactured by Stratasys, with model names Objet 24, 30, Object Eden 260V, 350V or 500V, Objet 260 Connex, Objet 350 Connex, Objet 500 Connex or Objet 100.

Apparatus for printing a 3D object may be controlled using a computing device. An example overview of processing data relating to a 3D object to be printed will now be described, including an explanation also of appropriately configured apparatus for this processing.

Data representative of an object for additive manufacturing may be stored using the stereolithography (STL) data format, the additive manufacturing data format (AMF), or, in accordance with examples to be described later, using a data format including surface precursor data (SPD), which data format herein is also referred to as the SPD data format.

An object to be additively manufactured may be designed using a computer aided design (CAD) or computer aided manufacturing (CAM) technique, using appropriate computer software operating on a computer, as would be well known to a person skilled in the art.

Once the 3D object has been designed and is ready for additive manufacture, data representative of the 3D object is generated. The data representative of the 3D object is herein referred to as object data and may be generated according to the STL, AMF or SPD data format, for example, by converting data in a data format used by CAD or CAM computer software to the STL, AMF or SPD data format.

To additively manufacture the object, the STL, AMF or SPD data is processed to generate data indicative of the object to be manufactured, including in some examples data defining a surface of the object to be printed, herein referred to as surface data. This processing includes interpreting the STL, AMF or SPD data and generating data indicative of the object to be manufactured in a format suitable for a particular additive manufacturing apparatus. For example, different manufacturers of additive manufacturing apparatus may use different signalling protocols for instructing the printing apparatus to operate. The processing of STL, AMF or SPD data may be conducted using data and instructions which are stored as part of a computer software module referred to herein as a build processor, although in other examples it is envisaged that functions of the build processor may be provided by different data implementations. The build processor may be configured to process data relating to a 3D object to be printed, for example object data, in order to generate data interpretable by a 3D printing apparatus to print a 3D object; in other words the build processor may process the object data to determine, i.e. build, the form of an object to be printed. The object data may include surface precursor data and may be received via a network. The build processor may process data representative of a 3D object to be printed, for example surface precursor data or surface data, described below, to generate data indicative of each slice for printing by a 3D printing apparatus. The build processor may then use this data indicative of each slice to instruct the 3D printing apparatus to print the object layer by layer. An operator may interact with and control processing of data representative of a 3D object using a computer software module referred to herein as a printing control module (not illustrated).

An example of apparatus for handling data relating to 3D printing of an object will now be described.

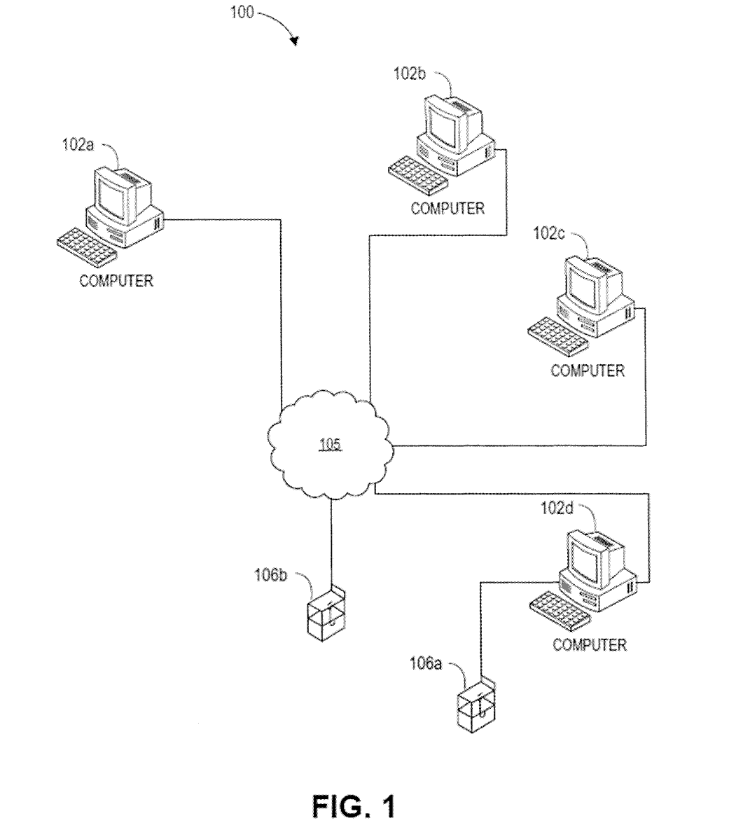

FIG. 1 illustrates schematically one example of apparatus 100 configured to process data in relation to designing and manufacturing a 3D object by 3D printing. The apparatus 100 may include one or more computers 102a-102d. The computers 102a-102d may take various forms such as, for example, any workstation, server, or other computing device capable of processing data. The computers 102a-102d may be connected by a computer network 105. The computer network 105 may be the Internet, a local area network, a wide area network, or some other type of network. The computers may communicate over the computer network 105 via any suitable communications technology or protocol. The computers 102a-102d may share data via the computer network 105 by transmitting and receiving data relating to for example computer software, data representing a 3D object, and data relating to commands and/or instructions to operate an additive manufacturing apparatus.

The system 100 may further include one or more additive manufacturing apparatuses 106a and 106b. These additive manufacturing apparatuses may each be a 3D printer as known in the art, for example an SLA, SLS, FDM or polyjet printing apparatus as described previously. In the example shown in FIG. 1, one of the additive manufacturing apparatuses 106a is connected to one of the computers 102d. The additive manufacturing apparatus 106a is therefore connected to the other computers 102a-102c via the network 105 which connects the computers 102a-102d. The additive manufacturing apparatus 106b is also connected to the computers 102a-102d by being directly connected to the network 105. A skilled person will readily appreciate that an additive manufacturing apparatus may be directly connected to a computer 102 via an input/output interface, such as a universal serial bus (USB) connection, or connected to the network 105 via for example a network interface card as part of the additive manufacture apparatus.

Although a specific computer and network configuration is described using FIG. 1, it will be appreciated that the additive manufacturing techniques described herein may be implemented using a single computer which controls and/or assists the additive manufacturing apparatus 106, without the need for a computer network.

It is further envisaged that data representative of a 3D object to be printed may be generated and/or processed using one computer 102a-d, and then transmitted via the network 105 to a different computer 102a-d for processing, for example using build processor data, to generate instructions for instructing operation of the additive manufacturing apparatus to print a 3D object.

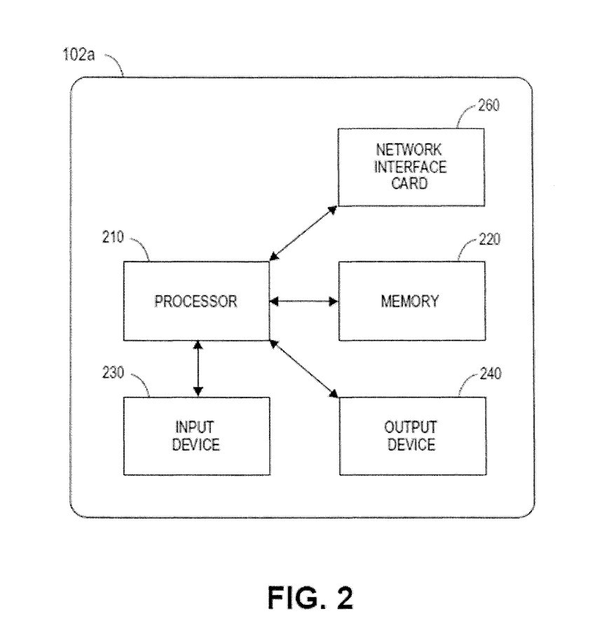

FIG. 2 shows schematically an example of one of the computers 102a-d of FIG. 1, namely the computer labelled 102a. The computer 102a includes a processor 210. The processor 210 is in data communication with various computer components. These components may include a memory 220, an input device 230, and an output device 240. In certain examples, the processor may also communicate with a network interface card 260 for data communication with the network 105. Although described separately, it is to be appreciated that functional blocks described with respect to the computer 102a need not be separate structural elements. For example, the processor 210 and network interface card 260 may be embodied in a single chip or board.

The processor 210 may be a general purpose processor, a digital signal processor (DSP), an application specific integrated circuit (ASIC), a field programmable gate array (FPGA) or other programmable logic device, a discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration. The processor 210 may be coupled, via one or more buses, to read information from or write information to the memory 220. The processor may additionally, or in the alternative, contain memory, such as processor registers. The memory 220 may include processor cache, including a multi-level hierarchical cache in which different levels have different capacities and access speeds. The memory 220 may further include random access memory (RAM), other volatile storage devices, or non-volatile storage devices. The memory may include data storage media of such as for example a hard drive, an optical disc, such as a compact disc (CD) or digital video disc (DVD), flash memory, a floppy disc, magnetic tape, solid state memory and Zip drives. The memory may be a record carrier comprising a data structure including surface precursor data in accordance with examples described herein and/or data executable to provide a method of data processing according to an example described herein. The memory may be a non-transitory computer-readable storage medium having computer readable instructions stored thereon, which when executed cause a computerized device to perform a method according of data processing according to an example described herein.

The processor 210 may also be coupled to an input device 230 and an output device 240 for, respectively, receiving input from and providing output to a user of the computer 102a. Suitable input devices include, but are not limited to, a keyboard, a rollerball, buttons, keys, switches, a pointing device, a mouse, a joystick, a remote control, an infrared detector, a voice recognition system, a bar code reader, a scanner, a video camera (possibly coupled with video processing software to, e.g., detect hand gestures or facial gestures), a motion detector, a microphone (possibly coupled to audio processing software to, e.g., detect voice commands), or other device capable of transmitting information from a user to a computer. The input device may also take the form of a touch screen associated with the display, in which case a user responds to prompts on the display by touching the screen. The user may enter textual information through the input device such as the keyboard or the touch-screen. Suitable output devices include, but are not limited to, visual output devices, including displays and printers, audio output devices, including speakers, headphones, earphones, and alarms, haptic output devices, and an additive manufacturing apparatus.

The processor 210 may further be coupled to a network interface card 260. The network interface card 260 is configured to prepare data generated by the processor 210 for transmission via a network according to one or more data transmission protocols, for example the Ethernet protocol. The network interface card 260 may also be configured to decode data received via the network. In some examples, the network interface card 260 may include a transmitter, receiver, or both. Depending on the specific example, the transmitter and receiver can be a single integrated component, or they may be two separate components. The network interface card 260 may be embodied as a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein.

The computer may for example be a desktop or laptop computing device. In other examples, the computer may be a mobile computing device such as a tablet device or a mobile telephone device such as a so called smartphone. Such a tablet device or mobile telephone device may comprise features of the computer described above with reference to FIG. 2; in some examples, the network interface card may be configured to interface with a mobile telecommunications network.

An additive manufacturing apparatus may for example include components of the computer described using FIG. 2, for example memory, which may include data for providing the build processor functionality, a processor, and an input and output interface, so that the additive manufacturing apparatus may for example receive and process data from the computer for controlling and instructing the additive manufacturing apparatus to print an object. In other examples, the functionality of the build processor could be provided in a hardware implementation, for example by a microchip.

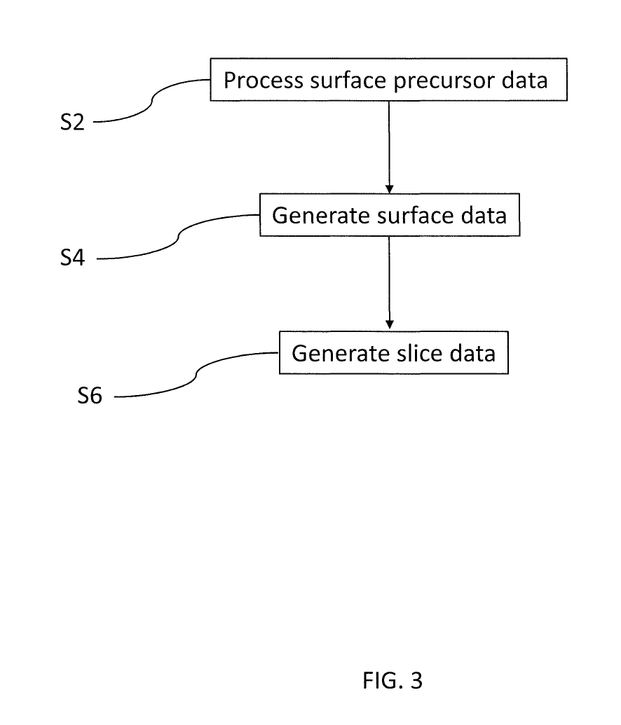

In accordance with examples now to be described, and with reference to FIG. 3, there is provided a method of processing data relating to at least part of a three dimensional object for additive manufacturing, the method including:

processing (S2) surface precursor data indicative of at least one characteristic for use in defining a surface of the at least part of the three dimensional object.

In some examples, the method includes generating, from said processing, slice data S6 corresponding to at least one slice of the three dimensional object for additive manufacturing of the three dimensional object.

In other examples, the method further includes an intermediate step of generating S4, from said processing, surface data representative of a surface of the at least part of the three dimensional object, which surface data is then processed to generate the slice data S6.

Surface precursor data is indicative of at least one characteristic for use in defining a surface of the at least part of the three dimensional object. The surface defined has a surface area, i.e. an area of the surface, and a configuration in 3D space. It is noted that a line defining a contour of the surface of an object is not considered herein to define a surface of the object, as it does not define a surface having a surface area.

Examples of the at least one characteristic are described further below. Surface precursor data is data which defines at least one precursor for use in defining the surface having the surface area and is data which does not directly represent a surface configuration of a part or of a whole of a three dimensional object, but data from which a configuration of a surface of a part or of a whole of a three dimensional object can be calculated. The surface precursor data may therefore be considered to indirectly define a configuration of a surface of at least part of an object to be printed.

Using surface precursor data allows the size of data files representative of an object for 3D printing to be notably reduced compared with other data formats such as STL or AMF. This reduced data file size means that data representative of an object for 3D printing can be transferred more quickly and efficiently over a data communications network. Further, hardware requirements of a computer and network requirements such as available bandwidth may be less demanding. Moreover, processing of the data file, for example using the build processor, to generate data such as slice data for instructing printing by an additive manufacturing apparatus, may be quicker and more efficient compared with known data formats such as STL and AMF formats.

Furthermore, for complex structures which are part of an object to be 3D printed, such as porous structures, mesh structures, lattice structures, and structures with intricate surface detail, the use of surface precursor data allows a reduced data file size to be used compared with known data formats such as STL and AMF data formats. Indeed, for particularly complex structures, the use of STL and AMF data formats is impractical, as the data file size is too large to be practically transmitted and/or processed.

In known data formats such as STL and AMF, the configuration of a surface of an object to be 3D printed is directly represented by data representative of a triangular mesh, i.e. a plurality of tessellating triangles. Note that a surface of an object is a surface area defining an extent of any part of the object. The surface can therefore define external surfaces of an object, and internal surfaces of an object for example which define a cavity or a porous structure within the object. For defining more complex surfaces, such as the surface of a porous structure, smaller triangles are used in known methods to provide the greater granularity needed to describe the complex surface. With smaller triangles a greater number of triangles is needed. In known data formats such as STL and AMF, each triangle of the triangular mesh is encoded by coordinate data for each of the three vertices of the triangle. Therefore, for a large number of small triangles, to describe a complex surface, the data size can become too large to be practical.

In contrast, as will become clear from examples below, the use of surface precursor data allows a surface of a complex object to be accurately defined yet with a significantly reduced data size.

In examples, the surface precursor data is indicative of one or more of a one dimensional feature and/or a two dimensional feature for defining the three dimensional form of the surface of the at least part of the three dimensional object, without the surface precursor data directly indicating the three dimensional form of the surface. The data required to represent such a one dimensional and/or two dimensional feature is notably less than required to represent directly a surface of a three dimensional object using a triangular mesh, particularly where the surface is complex and intricate. Given the need in 3D printing to accurately define the surface of the object for printing, it may be considered counterintuitive to use data for defining a surface of a 3D object which does not directly represent the surface configuration. It is true that known methods using data defining a triangular mesh lead to accurate 3D printed objects. However, in examples described herein, it has been found that surface precursor data, although not directly representing the surface configuration of an object to be printed, is nonetheless suitable for generating a sufficiently accurate surface configuration for an object to be printed. Moreover, such surface precursor data is suitable for accurate printing of complex and intricately structured objects, and has a significantly reduced data size compared with triangular mesh data.

The surface precursor data is indicative of at least one characteristic for defining a surface of at least part or a whole of the three dimensional object.

In examples, the at least one characteristic for defining a surface includes at least one longitudinal axis of the at least part of the three dimensional object. The at least one characteristic may include a framework of the at least part of the three dimensional object. The characteristic may include a wireframe model of the framework. The framework may be defined by a graph of at least one pair of vertices linked by an edge defining a part of the framework. Using a graph representing a framework of the object has the benefit that an edge of the graph may be sliced easily, at any point along the edge. Slice data may therefore be generated using simple algorithms which don't need to operate on more complex data representing two or three dimensional shapes. The at least one characteristic may include a thickness or a diameter corresponding to a part of the framework and defining an extent of part of the surface of the at least part of the three dimensional object.

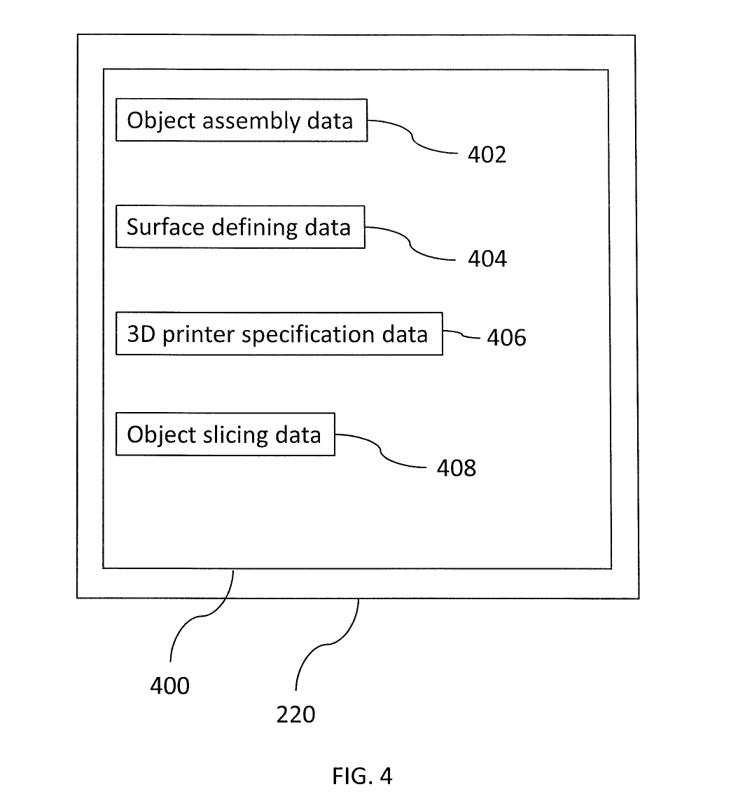

An example of surface precursor data, and its processing to generate data for defining a surface of a 3D object for printing, will now be described with reference to FIGS. 4 to 7.

FIG. 4 shows schematically an example of the build processor 400 mentioned previously. Computer software, i.e. computer implementable instructions, which provide the functionality of the build processor are stored for example in the memory, for example on a hard drive, of a computer such as one of the computers 102a-d described previously. Processing of the build processor data and instructions, by the processor of the computer, provides the functions of the build processor described herein.

As illustrated by FIG. 4, the build processor in this example includes the following sub-modules: object assembly data 402; surface defining data 404; 3D printer specification data 406 and object slicing data 408. In other examples the build processor may include fewer of these sub-modules.

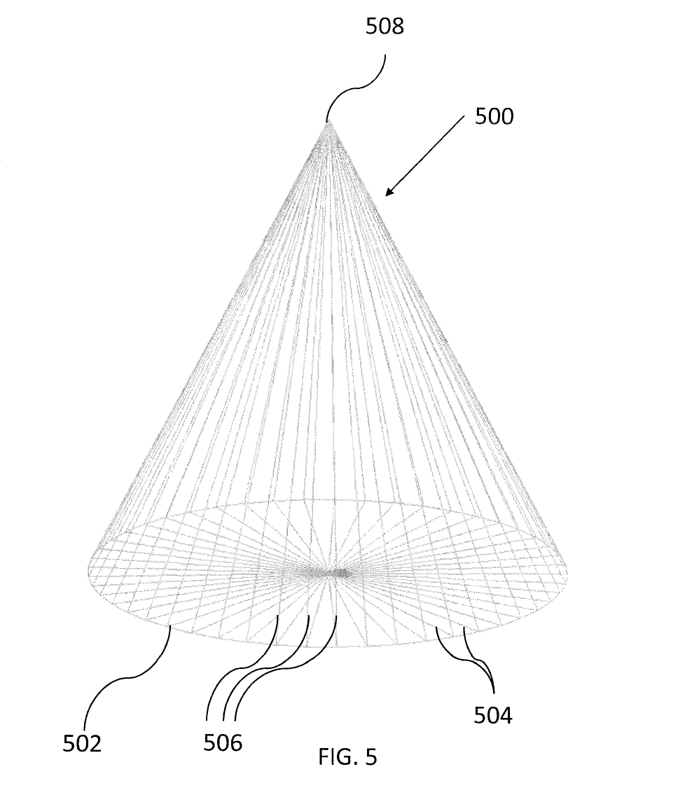

In the present example, with reference to FIG. 5, the surface precursor data is indicative of a conical wireframe 500 including a circular base 502 with a plurality of longitudinal axes 504 defining radial spokes of the circular base, and a plurality of longitudinal axes 506 connecting an outer end of each radial axis to the apex 508 of the cone. The surface precursor data is indicative of the longitudinal axes 504, 506. The surface precursor data in this example includes data indicative of a graph of at least one pair of vertices linked by an edge, each edge defining one of the longitudinal axes 504, 506. The surface precursor data further includes data indicative of the positional relationship of one edge to at least one of the other edges in three dimensional space. The graph data may be 3D space coordinate data for each vertex of a pair of vertices defining an edge. The wireframe model 500 represents a framework of the object to be printed.

An example of processing data relating to at least part of a three dimensional object for additive manufacturing will now be described. This method relates to that method described with FIG. 3 previously, but in further detail.

Firstly, object data may be received for example via the Internet. Object data includes data relating to a 3D object to be printed. The object data in examples described herein includes surface precursor data. In the present example, the surface precursor data is representative of a wireframe model of a framework of an object to be printed, corresponding in this example to the wireframe illustrated in FIG. 5. The object data may be received via a data network from a different computer than the computer loaded with the build processor, and for example may be an Internet downloaded 3D print file of data representing an object for 3D printing. Alternatively, the object data may have been generated using object design software loaded on the same computer as the computer on which the build processor is loaded.

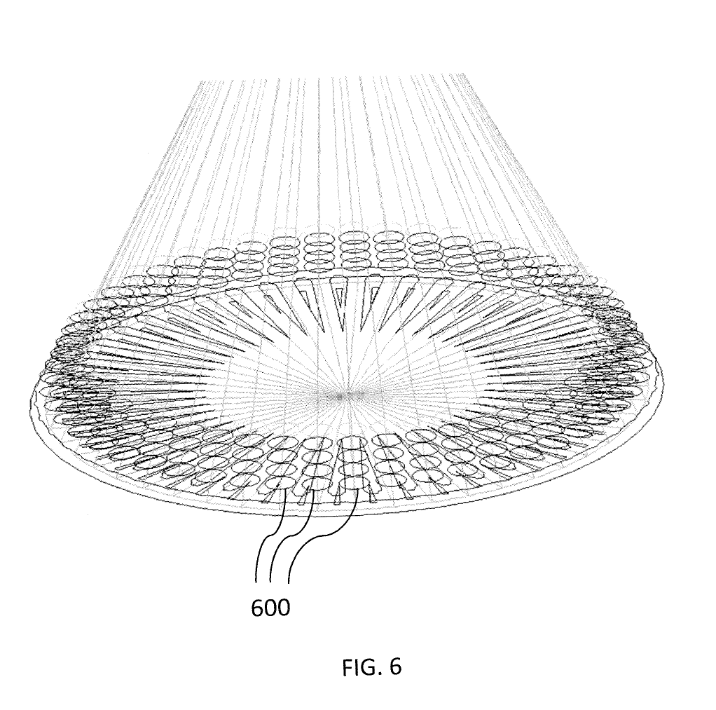

The received object data is processed to generate surface data which is representative of a surface of at least part of the 3D object for printing. The surface precursor data may be indicative of a characteristic including a thickness or a diameter corresponding to a part of the framework and defining an extent of part of the surface of the at least part of the three dimensional object. An example is illustrated in FIG. 6 where for each longitudinal axis 506 connected to the apex 508 the surface precursor data is indicative of a diameter 600 of a circular cross section, of a cylindrical longitudinal part of the object at one or more locations, on the longitudinal axis. The diameter corresponds with a surface contour of the object. The cross section is taken perpendicular to the longitudinal axis 506. In this example, the diameter is indicated by the surface precursor data for a plurality of locations along a longitudinal axis, thereby defining an extent of the surface of the cylindrical longitudinal part at each location. Each diameter may be different or a standard diameter. Each location where the diameter is indicated may correspond with a slicing plane (to be described further below) or at coordinates, specified by the surface precursor data, along the longitudinal axes. The surface of the cylindrical longitudinal part may be determined along the longitudinal axis by interpolation between the diameters at each location along the longitudinal axis.

For each radial axis 504, the surface precursor data is indicative of a thickness of a radial part of the circular base, the thickness being taken in the plane of the circular base. This thickness may be specified by data indicating a thickness at specified locations along each radial axis. The depth of each radial part may also be indicated by the surface precursor data.

In examples, the processing of the surface precursor data includes interpreting the surface precursor data and receiving surface defining data in accordance with the interpretation of a code of the surface precursor data for use in generating the surface data. The object assembly data 402 may be used in this processing, the object assembly data 402 including for example data indicative of an algorithm for processing the object data, including the surface precursor data, and assembling data representative of the object to be printed, and thereby generating the surface data. In the present example, the surface precursor data indicates as described above a diameter of cylindrical longitudinal parts. Rather than the surface precursor data defining the diameter line, for example using spatial coordinate data, the surface precursor data may instead indicate a predetermined shape having a predetermined size to define the cross section at a given location on the longitudinal axis. For example, the surface precursor data may indicate a code indicative of a circular shape with a given diameter. Data indicative of available predetermined shapes and sizes may be stored in a database for example as the surface defining data 404 in the build processor. Therefore, when processing and thereby interpreting the surface precursor data, the surface defining data 404 may be queried in accordance with the interpretation of the surface precursor data. Surface defining data corresponding with for example the predetermined shape and size of the circular cross section may be selected in response to the querying using the code and received, for example by the processor 210, to define the extent of the surface of the cylindrical part at a given location.

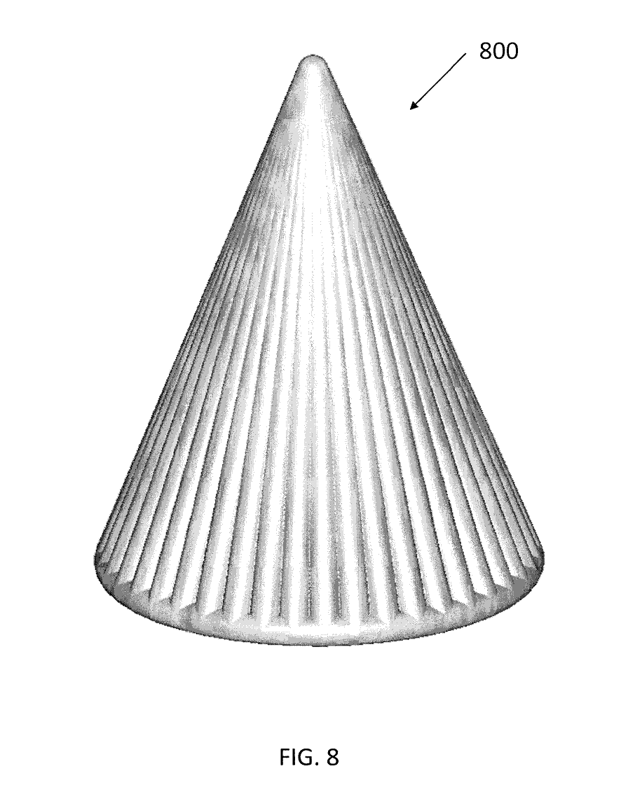

In accordance with the example described using FIGS. 5 and 6, FIG. 7 illustrates schematically, by each circle illustrated, the surface contour of the object 700 at a plurality of locations along the longitudinal axes, once processing of the surface precursor data is complete. In this example each location coincides with a slice plane SP as will be described below. Surface data is therefore generated which indicates the surface configuration of the object at at least certain locations of the object, or for the whole surface of the object to be printed, for example as a result of interpolation of the surface configuration between the surface contours defined at each location. FIG. 8 shows the surface of the object 800 represented by the surface data, for the example described using FIGS. 5, 6 and 7.

In order to print an object, slice data is generated. As described above, a 3D printer prints layers of the object one by one. Therefore, the 3D printer needs to be instructed with data indicative of the form of each layer to be printed. The slice data corresponds with at least one slice of the object, as explained below. The slice data is used for instructing the 3D printer to print at least one layer of the object, each slice corresponding with a layer of the object to be printed. In examples, the slice data is generated by processing surface data representative of the at least part of the three dimensional object for printing. The surface data may for example include data indicative of the surface at the plurality of locations along longitudinal axes as described above. Or, in other examples, any data defining the surface configuration may be processed to generate slice data. In further examples, the surface precursor data may be processed to generate slice data without the intermediate step of generating surface data; in such examples, processing of the surface precursor data may use the surface defining data to determine a surface contour for a two dimensional slice when generating a slice of the object for printing; in one such example, a longitudinal axis may be sliced at a location corresponding with a slicing plane SP, and the surface defining data queried to determine a circular cross section of the part of the object at the slicing plane. The slice data when generated may be transmitted to a 3D printer for instructing the 3D printer to print the object.

Slicing may be performed using the build processor. For example, data representative of a surface of an object to be printed may be sliced at a plurality of regularly spaced slice planes. Slice data representative of one slice represents a two dimensional, planar, slice indicative of an extent and form of the surface of the object at a given location, i.e. at a slice plane. The 3D printer is configured to interpret the two dimensional slice data to print at least one layer of printing material corresponding with at least one slice, to print the object.

In the slicing process, data 406 indicative of the specifications of the 3D printer to be used for printing the object may be used. For example, the 3D printer specification data may indicate the standard thickness of a layer of material which is printed, and the type of material the 3D printer is configured to print. Using this specification data 406, the surface data representative of the surface of the object to be printed may be processed to slice the object accordingly for printing, to ensure that the slice data is compatible with the 3D printer so that the object can be printed accurately. Object slicing data 408 may be used in this slicing process, the object slicing data including data indicative for example of an algorithm for processing the surface data in accordance with the specification data 406 in order to generate slice data.

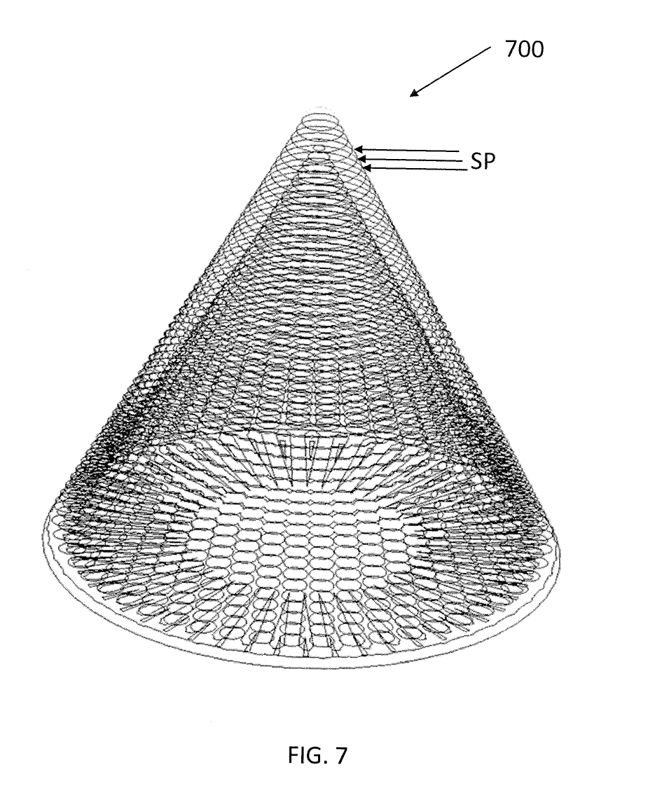

Referring to FIG. 7, for example, a plurality of slice planes SP is illustrated, each of these in this example corresponding with one of the locations along the length of the longitudinal axes. Each line shown in FIG. 7 illustrates a contour line at a surface of the object to be printed, at a plurality of regularly spaced slice planes.

In generating slice data, the surface data may first be generated from the surface precursor data completely, to define the surface data for the entire surface of the object to be printed, before generating the slice data. Alternatively, the surface precursor data may be processed to generate surface data per slice, which is then processed to generate slice data for one slice at a time. Or, as described above, slice data may be generated from surface precursor data without first generating surface data.

Further examples of characteristics of which the surface precursor data is indicative will now be described.

In an example, the at least one characteristic includes a label for labelling the at least part of the three dimensional object. The surface precursor data may include data indicative of label indicia, for example alphanumerical characters, and possibly also the font size and/or type, to be provided on a surface of an object to be printed. Thus a label may be provided on the object for printing. When the surface precursor data is processed to generate surface data and consequently slice data, the surface at a given location of the object, for example a slice plane, is defined in accordance with the surface contours required to provide the alphanumerical characters indicated by the surface precursor data. The surface defining data 404 of the build processor may include data indicative of the surface contours required to provide a specified alphanumeric character of a particular font type and size. Thus, the surface precursor data is indicative of surface contours of an object to be printed, relative to a surface surrounding the label of the object, which contours are representative of label indicia of the at least part of the three dimensional object. In this way, the surface data for the object to be printed may be generated to represent surface contours representative of a label. By using the surface precursor data to indicate a label, an object may be easily printed with a label such as a part reference number or a serial number. This is more efficient and gives a reduced data size of data file compared with using a triangular mesh to describe an alphanumerical label for example.

In other examples, the at least one characteristic includes a material and/or colour for at least part of the three dimensional object. For example, the characteristic may define a type of material to be used for the at least part of the three dimensional object. Further, a material and/or a colour of at least one part of the three dimensional object may be different than a material and/or colour of at least another part of the three dimensional object. In some such examples, the surface precursor data may include data indicative of a material and/or colour for each of any number of different parts of the three dimensional object.

In another example, the at least one characteristic includes a surface texture for the surface of the at least part of the three dimensional object, the surface precursor data being indicative of surface contours, relative to a surface surrounding the surface texture, representative of the surface texture of the at least part of the three dimensional object. For example, where the surface texture is a regularly repeating texture, the surface precursor data may include data indicative of a code corresponding to a predetermined surface texture and coordinate data indicative of the locations of the object to be printed where the surface texture is to be applied. The surface defining data 404 may include data indicative of a plurality of surface textures which may be applied to the surface of an object to be printed. Therefore, when the surface precursor data is processed, the code may be interpreted and the corresponding surface texture identified from the surface defining data 404. The surface data of the object to be printed may therefore be generated to define a desired surface texture at a specified location on the object.

In other examples, instead of the surface precursor data being indicative of a predetermined surface texture, the surface precursor data may include data indicative of a custom surface texture. The surface precursor data may include data indicative of at least one contour corresponding to one or more two dimensional slices of an object; the surface contour data may define the custom texture at a given location of the object. Further details on the surface precursor data including slice data are explained below.

In further examples where the at least one characteristic includes a surface texture for the surface of the at least part of the three dimensional object, the surface precursor data may include image data, for example in the form of a bitmap (BMP) data format, a graphical interchange format (GIF) data format, or a joint photographic experts group (JPEG) data format. The image data may be indicative of surface contours, relative to a surface surrounding the surface texture indicated by the image data, representative of the surface texture. Thus, the image data may for example represent a texture to be applied to the surface of at least part of the object to be printed. The image data may be applied to a region of the surface of an object to be printed. The surface defining data 404 may include data for processing such graphical image data and generating surface data corresponding to the surface texture indicated by the graphical image data. Therefore, for example, the surface defining data may indicate that for a certain brightness or intensity level in the image data, at a certain location on the object, the surface of the object should be raised or lowered by a certain extent compared with the position of the surface surrounding that location on the object, i.e. a reference surface. In this way, the surface of part of the object may be accurately defined to provide a surface texture indicated by the image data.

In other examples, the at least one characteristic includes at least one two dimensional slice of the at least part of the three dimensional object. The two dimensional slice may define a contour corresponding with the configuration of the surface of the object at one slice plane. For example, a custom surface texture for one slice may be defined by the surface contour of the two dimensional slice.

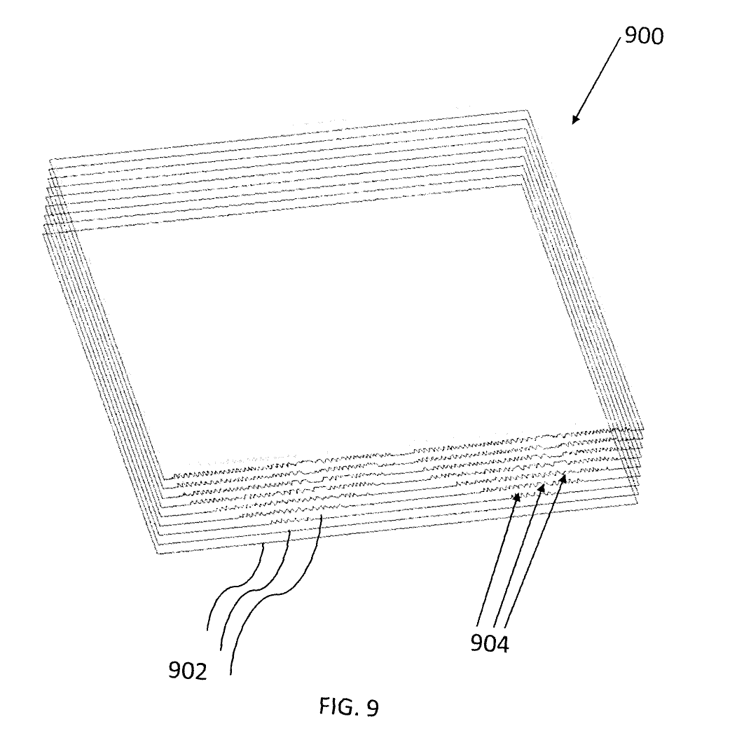

In some examples, the at least one two dimensional slice includes a stack of a plurality of two dimensional slices of the at least part of the three dimensional object. The surface precursor data representative of the two dimensional slices may be processed to generate slice data, possibly by the intermediate step of generating surface data which is then sliced. An example is shown for example in FIG. 9 which illustrates schematically a stack 900 of a plurality of two dimensional slices 902. In this example each slice 902 is spaced regularly from an adjacent slice in the stack. The spacing may correspond with a thickness of material printed by the 3D printer for each layer. Therefore, any processing of the surface precursor data to generate slice data may be minimal. As mentioned previously, a surface texture of the object at a given location may be defined by a surface contour of data representative of a two dimensional slice. This is illustrated in FIG. 9 by surface contours 904 of a plurality of slices 902 which together when printed define a surface texture of the surface of the object to be printed.

When generating surface data for the object to be printed, the processing of the surface precursor data may for example include defining a surface of the at least part of the three dimensional object between a surface contour of a first slice of the stack and a surface contour of a second slice of the stack. In this way, the surface of the object may be defined between the slices in the stack. In other examples, each slice may correspond directly with a layer to be printed by a 3D printer, for example with each slice in the stack being spaced according to a thickness of material for printing of each layer by the 3D printer, without requiring further processing for preparation in a required data format for the 3D printer.

Including slice data in the object data is an efficient manner to store data for defining a surface of an object to be printed. Complex surface textures may be defined on a two dimensional slice basis, without needing data representing a complex triangular mesh which would have a large data size. Moreover, if surface precursor data corresponds with slice data for instructing a 3D printer, providing of slice data to instruct the 3D printer may be performed more efficiently, and quickly, as processing to generate slice data is not first required.

In further examples the surface precursor data may be provided for a part of a 3D object to be printed. This part may correspond with a volume unit of the object which is repeated elsewhere in the object. The volume unit may for example be a lattice or mesh structure, or for example the cylindrical part referred to previously using FIGS. 5 to 7. The surface precursor data may be indicative of at least one characteristic for defining a surface of the volume unit. The object data may further include data, for example coordinate data, indicative of locations in the object where the volume unit is repeated. In this way, it is not necessary for the object data to include surface precursor data indicative of the surface of each volume unit which is repeated, but instead such surface precursor data only need be provided once, resulting in a notably reduced data size of the object data, for defining the surface of the whole object.

It is envisaged that object data may include triangular mesh data representative of a surface of a part of the three dimensional object, in addition to the object data including surface precursor data. In this way, pre-existing data representing a triangular mesh corresponding with a surface of at least part of an object to be printed may be re-used when generating new object data. Or, where a triangular mesh might be more suitable at defining a surface of part of an object to be printed, triangular mesh data may be provided in the object data in addition to surface precursor data for a part of the object which is more suitably represented by surface precursor data.

The above examples are to be understood as illustrative. Further examples are envisaged. For example, the object data may include further parameters for the object to be printed, for example a material and/or a colour of at least part of the object. In some examples, the object data may include different parameters for different parts of the object to be printed, for example a material and/or a colour of at least one part of the object may be different than a material and/or colour of at least another part of the object. In some examples, the object data may include different such parameters for any number of different parts of the object.

Although one example of processing data in relation to printing an object has been described above using FIGS. 5 to 8, it is to be appreciated that many other examples of objects are envisaged for printing using the examples of data processing methods and apparatus described herein. For example, any object which may be drawn with a closed polyline may be printed using the methods described herein.

It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the accompanying claims.

1. A method of processing data relating to at least part of a three dimensional object for additive manufacturing, the method including:
processing surface precursor data indicative of at least one characteristic for use in defining a surface of the at least part of the three dimensional object.

2. A method according to claim 1, including generating, from said processing, slice data corresponding to at least one slice of the three dimensional object, for additive manufacturing of the three dimensional object.

3. A method according to claim 1, including generating, from said processing, surface data representative of a surface of the at least part of the three dimensional object.

4. A method according to claim 3, including generating slice data corresponding to at least one slice of the three dimensional object, for additive manufacturing of the three dimensional object, said generating of slice data including processing said surface data.

5. A method according to claim 1, wherein the surface precursor data is indicative of one or more of a one dimensional feature and/or a two dimensional feature for defining the three dimensional form of the surface of the at least part of the three dimensional object, without said surface precursor data directly indicating the three dimensional form of the surface.

6. A method according to claim 1, wherein the at least one characteristic includes at least one of the following: at least one longitudinal axis of the at least part of the three dimensional object; a framework of the at least part of the three dimensional object; and a wireframe model of a framework of the at least part of the three dimensional object.

7. A method according to claim 6, wherein the framework is defined by a graph of at least one pair of vertices linked by an edge defining a part of the framework.

8. A method according to claim 6, wherein the at least one characteristic includes a thickness or a diameter corresponding to a part of the framework and defining an extent of part of the surface of the at least part of the three dimensional object.

9. A method according to claim 1, wherein the at least one characteristic includes a label for labelling the at least part of the three dimensional object.

10. A method according to claim 9, wherein the surface precursor data is indicative of surface contours, relative to a surface surrounding the label, representative of label indicia of the at least part of the three dimensional object.

11. A method according to claim 1, wherein the at least one characteristic includes a surface texture for the surface of the at least part of the three dimensional object, said surface precursor data being indicative of surface contours, relative to a surface surrounding the surface texture, representative of the surface texture of the at least part of the three dimensional object.

12. A method according to claim 1, wherein the at least one characteristic includes a surface texture for the surface of the at least part of the three dimensional object, the surface precursor data including image data indicative of surface contours, relative to a surface surrounding the surface texture, representative of the surface texture of the at least part of the three dimensional object.

13. A method according to claim 1, wherein the at least one characteristic includes at least one slice of the at least part of the three dimensional object.

14. A method according to claim 13, wherein the at least one slice includes a stack of a plurality of slices of the at least part of the three dimensional object.

15. A method according to claim 14, wherein said processing includes defining a surface of the at least part of the three dimensional object between a surface contour of a first slice of the stack and a surface contour of a second slice of the stack.

16. A method according to claim 1, wherein the surface precursor data is indicative of a surface of a volume unit of a part of the three dimensional object and at least one location in the three dimensional object where said volume unit is repeated.

17. A method according to claim 1, said processing including interpreting the surface precursor data and receiving surface defining data in accordance with said interpretation of the surface precursor data for use in generating the surface data and/or the slice data.

18. A method according to claim 17 including querying a database of surface defining data in accordance with the interpretation of the surface precursor data, said received surface defining data having been selected from the database in response to said querying.

19. A method according to claim 1, wherein the surface precursor data is comprised by object data relating to the at least part of the three dimensional object, the object data further comprising triangular mesh data representative of a surface of a part of the three dimensional object.

20. A method according to claim 1, wherein the at least one characteristic includes a first material for a first part of the three dimensional object and a second material for a second part of the three dimensional object.

21. The method of claim 1, further comprising:
receiving said surface precursor data; and
transmitting slice data to additive manufacturing apparatus, for instructing the additive manufacturing apparatus to additively manufacture said at least part of the three dimensional object, wherein the processing comprises generating said slice data corresponding to at least one slice of the at least part of the three dimensional object.

22. Apparatus for processing data relating to at least part of a three dimensional object for additive manufacturing, the apparatus comprising:
at least one processor; and
at least one memory including computer program instructions,
the at least one memory and the computer program instructions being configured to, with the at least one processor, cause the apparatus to perform:
a method of generating data relating to at least part of a three dimensional object for additive manufacturing, the method including:
processing surface precursor data indicative of at least one characteristic for use in defining a surface of the at least part of the three dimensional object.

23. The apparatus of claim 22, wherein the method further comprises:
receiving said surface precursor data; and
transmitting slice data to additive manufacturing apparatus, for instructing the additive manufacturing apparatus to additively manufacture said at least part of the three dimensional object, wherein the processing comprises generating said slice data corresponding to at least one slice of the at least part of the three dimensional object.

24. A computer program product comprising a non-transitory computer-readable storage medium having computer readable instructions stored thereon, the computer readable instructions being executable by a computerized device to cause the computerized device to perform a method of processing data relating to at least part of a three dimensional object for additive manufacturing, the method including:
processing surface precursor data indicative of at least one characteristic for use in defining a surface of the at least part of the three dimensional object.
